(19) United States
(12) Patent Application Publication
(10) Pub. No.: US 2023/0062541 A1
(43) Pub. Date: Mar. 2, 2023

(54) CONTROLLER AND CONTROLLING METHOD OF OPERATING FUEL CELL

(71) Applicants: HYUNDAI MOTOR COMPANY, SEOUL (KR); KIA CORPORATION, SEOUL (KR)

(72) Inventor: Jung Hwan RYU, Suwon-si (KR)

(21) Appl. No.: 17/866,065

(22) Filed: Jul. 15, 2022

(30) Foreign Application Priority Data
Sep. 1, 2021 (KR) 10-2021-0116032

(51) Int. Cl. B60L 58/40; B60L 58/12; H01M 8/04858

(52) U.S. Cl. CPC B60L 58/40; B60L 58/12; H01M 8/04932; H01M 2250/20

(57) ABSTRACT

A controller and a controlling method of operating a fuel cell are provided. The controller for operating a fuel cell in a system, the system being configured to generate an output through the fuel cell and a battery, includes an input part configured to receive a system request output of a user, a calculating part configured to calculate a fuel cell output by excluding a battery output from the system request output of the user, the battery output being derived through a plurality of factors, the plurality of factors including residual available energy of the fuel cell, and an operating part configured to control the operation of the fuel cell in response to the fuel cell output calculated by the calculating part.

### CROSS REFERENCE TO RELATED APPLICATION

The present application claims priority to Korean Patent Application No. 10-2021-0116032, filed Sep. 1, 2021, the entire contents of which is incorporated herein for all purposes by this reference.

### BACKGROUND

### Field

The present disclosure relates generally to a controller and a controlling method of operating a fuel cell and, more particularly, to a controller and a controlling method of operating a fuel cell, which are configured, in controlling an output value of the fuel cell, to stably satisfy a variable output request of a user not only by output data of the fuel cell, but also in consideration of battery state of charge (SOC) calculated in an output limit state situation, and to increase the durability of the fuel cell by variably deriving an output command value of the fuel cell in response to a durability condition of the fuel cell.

### Description of Related Art

In a fuel cell system, when the maximum output of a fuel cell is limited, or high output is continuously demanded, to improve the durability of the fuel cell, a general controlling method is performed by limiting usage time according to the output value. However, the output used from the fuel cell has a continuous value less than the maximum output. Therefore, when the output is not a preset output value, an output limit time may not be known with the existing information. Therefore, there is a need for a technique for generating output limit time information at output points other than a specific output value for which output limit information is provided.

Furthermore, in a system to which both a fuel cell system and a high capacity battery are applied, when the fuel cell output is insufficient, the battery may supply insufficient output. Therefore, a technique preparing to supply the total request output in the fuel cell output limit by preemptively charging the battery on the basis of the fuel cell output limiting time is required.

The foregoing described as the controller and the controlling method of operating a fuel cell is intended merely to aid in the understanding of the background of the present disclosure, and is not intended to mean that the present disclosure falls within the purview of the related art that is already known to those skilled in the art.

### SUMMARY

The present disclosure provides a controller and a controlling method of operating a fuel cell, which are configured, in controlling an output value of the fuel cell, to stably satisfy a variable output request of a user not only by output data of the fuel cell, but also in consideration of the battery SOC calculated in the situation of an output limit state, and to increase the durability of the fuel cell by variably deriving an output command value of the fuel cell in response to a durability condition of the fuel cell.

In order to achieve the above objective, according to one aspect of the present disclosure, there is provided a controller for operating a fuel cell in a system, the system being configured to generate an output through the fuel cell and a battery, the controller including an input part configured to receive a system request output of a user, a calculating part configured to calculate a fuel cell output by excluding a battery output from the system request output of the user, the battery output being derived through a plurality of factors, the plurality of factors including residual available energy of the fuel cell, and an operating part configured to control the operation of the fuel cell in response to the fuel cell output calculated by the calculating part.

The calculating part may be configured to derive the residual available energy of the fuel cell by subtracting an accumulative consumed energy from an initial available energy of the fuel cell.

The calculating part may be configured to derive the initial available energy and the accumulative consumed energy of the fuel cell on the basis of a plurality of output limit values preset as different values and fuel cell available time corresponding to the output limits.

In deriving the initial available energy of the fuel cell, the calculating part may derive the initial available energy of the fuel cell on the basis of a lowest minimum output limit value of the plurality of output limit values and maximum fuel cell available time corresponding thereto.

The calculating part may be configured to derive residual available time of the fuel cell on the basis of the residual available energy of the fuel cell and an output value of the fuel cell.

The factors of the calculating part may include the residual available energy of the fuel cell and a state of charge (SOC) of the battery.

The factors of the calculating part may include the residual available energy of the fuel cell and the system request output of the user.

The factors of the calculating part may include the residual available energy of the fuel cell, a state of charge (SOC) of the battery, and the system request output of the user.

The calculating part may be configured to derive the battery output through Equation 1.

$${P}_{bat} = {η}_{1} \times {P}_{req} + {η}_{2} \times SOC + {η}_{3} \times ( \frac{Δ E}{{E}_{0}} - 1 ) \times {P}_{req} \qquad [ Equation 1 ]$$

Wherein P_{bat} is the output of the battery, η₁, η₂, and η₃ are constants, SOC is a state of charge of the battery, ΔE is the residual available energy of the fuel cell, E₀ is an initial available energy of the fuel cell, and P_{roq} is the system request output of the user.

The residual available energy of the fuel cell may be variably derived on the basis of a parameter changed as accumulative usage time of the fuel cell is increased.

The residual available energy of the fuel cell may be reduced as the parameter is reduced, the parameter being changed as the accumulative usage time of the fuel cell is increased.

The parameter may be a ratio of a voltage value in an initial performance state of the fuel cell to a voltage value due to reduced durability after the accumulative usage time of the fuel cell, with respect to a preset output value of the fuel cell.

According to another aspect of the present disclosure, there is provided a controlling method of operating a fuel cell in a system, the system being configured to generate an output through the fuel cell and a battery, the controlling method including receiving, by an input part, a system request output of a user, deriving, by a calculating part, an output of the battery through a plurality of factors including residual available energy of the fuel cell, calculating, by the calculating part, an output of the fuel cell by excluding the output of the battery from the system request output of the user, and controlling, by an operating part, operation of the fuel cell in response to the output of the fuel cell.

In the deriving, by the calculating part, the output of the battery through the plurality of factors including the residual available energy of the fuel cell, the residual available energy of the fuel cell may be derived by subtracting accumulative consumed energy from initial available energy of the fuel cell.

In the deriving, by the calculating part, the output of the battery through the plurality of factors including the residual available energy of the fuel cell, the residual available energy of the fuel cell may be variably derived on the basis of a parameter, the parameter being changed as an accumulative usage time of the fuel cell is increased.

According to the present disclosure, the controller and the controlling method of operating a fuel cell can provide effects in that, in controlling an output value of the fuel cell, a variable output request of a user can be stably satisfied not only by output data of the fuel cell, but also in consideration of the battery SOC calculated in case of an output limit state, and the durability of the fuel cell can be increased by variably deriving an output command value of the fuel cell in response to a durability condition of the fuel cell.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram showing a controller for operating a fuel cell according to an embodiment of the present disclosure;

FIG. 2 is a graph showing output-weight of the fuel cell with application of the controller for operating a fuel cell according to the embodiment of the present disclosure;

FIG. 3 is a graph showing an initial voltage of the fuel cell and a voltage of the fuel cell after a preset usage time of the fuel cell, with respect to a preset output value of the fuel cell in the controller for operating a fuel cell according to the embodiment of the present disclosure;

FIG. 4 is a graph showing output-weight with application of the controller for operating a fuel cell according to the embodiment of the present disclosure; and

FIG. 5 is a flowchart showing a controlling method of operating a fuel cell according to an embodiment of the present disclosure.

### DETAILED DESCRIPTION

In the following description, the structural or functional description specified to exemplary embodiments according to the concept of the present disclosure is intended to describe the exemplary embodiments, so it should be understood that the present disclosure may be variously embodied, without being limited to the exemplary embodiments. Hereinbelow, an embodiment of the present disclosure will be described with reference to accompanying drawings.

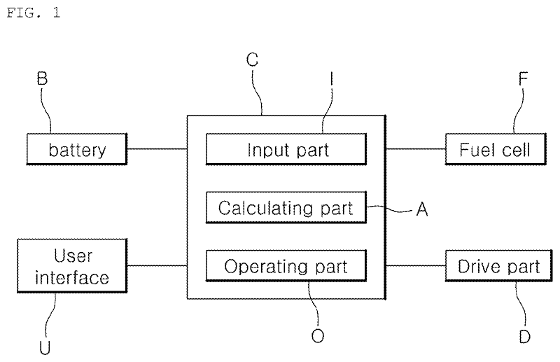

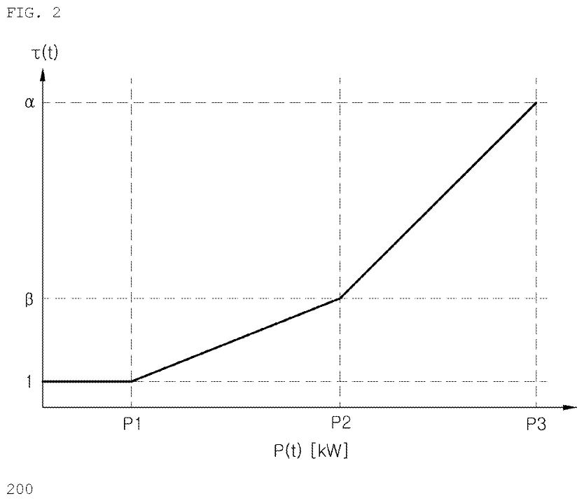

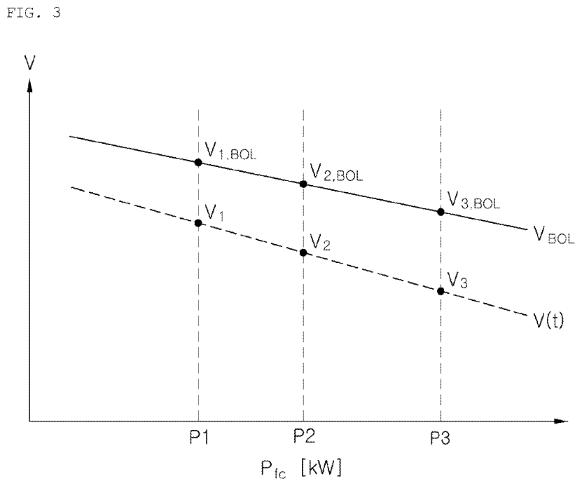

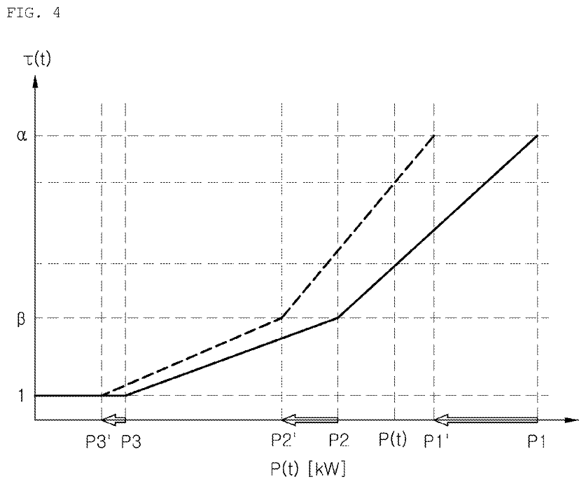

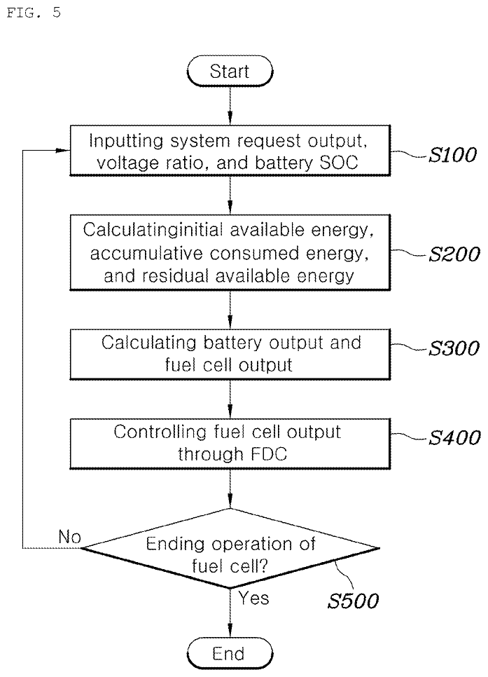

FIG. 1 is a block diagram showing a controller for operating a fuel cell according to an embodiment of the present disclosure. FIG. 2 is a graph showing output-weight of the fuel cell with application of the controller for operating a fuel cell according to the embodiment of the present disclosure. FIG. 3 is a graph showing an initial voltage of the fuel cell and a voltage of the fuel cell after a preset usage time of the fuel cell, with respect to a preset output value of the fuel cell, in the controller for operating a fuel cell according to the embodiment of the present disclosure. FIG. 4 is a graph showing output-weight with application of the controller for operating a fuel cell according to the embodiment of the present disclosure. FIG. 5 is a flowchart showing a controlling method of operating a fuel cell according to an embodiment of the present disclosure.

FIG. 1 is the block diagram 100 showing the controller for operating the fuel cell according to the embodiment of the present disclosure, and the fuel cell operation controller C is an upper system operated by receiving information about a vehicle and an application (hereinbelow, which are referred to a vehicle, etc.) and by limiting an output or operation of the fuel cell. Specifically, in a system generating an output required for driving a motor through a fuel cell F and a battery B as the embodiment of the present disclosure, an input part I receives a battery state of charge (SOC) from the battery B, a fuel cell output from the fuel cell F, and a system request output from an user interface U, as the information of a vehicle, etc.

The battery B of the present disclosure may include a high voltage battery supplying electric energy for driving a drive motor of the vehicle. The user interface U includes various input means such as an accelerator and a brake pedal, and a voice recognition unit as a driver requests acceleration or deceleration. The user interface may be configured to receive a request of the driver for acceleration or deceleration and to convert the request into the system request output and to provide the system request output. The input part I may receive information about an output limit value of each device F, B for improving the durability of a vehicle, and other aspects.

A calculating part A derives a battery output P_{bat} on the basis of the information of a vehicle, etc. input from the input part, and calculates a fuel cell output P_{fc} by excluding the battery output P_{bat} from a system request output P_{req} (P_{fc}=Preq−P_{bat}). An operating part O converts a signal in response to an output command value of the fuel cell calculated from the calculating part A through a fuel cell DC-DC converter (FDC, the fuel cell output converter), etc., and finally controls operation of the fuel cell. A driver part D drives a vehicle, etc. through the motor in response to the fuel cell output and the battery output that are controlled as described above.

The present disclosure is a drive system generating an output through the fuel cell and the battery. The existing system allows the output of the fuel cell to charge the battery and to drive a vehicle, or perform other vehicle operations. Therefore, the output of the fuel cell is calculated in consideration of the battery SOC and a residual hydrogen storage amount of a vehicle, etc. When the SOC of the existing battery is high, or the residual hydrogen storage amount of a vehicle, etc. is low, the output command value of the fuel cell is reduced. Conversely, when the SOC of the existing battery is low or the residual hydrogen storage amount of a vehicle, etc. is high, the system calculates the output command value of the fuel cell to be high. However, the system described above is unsuitable for a fuel cell (e.g., system applied to commercial, tram, etc.) of a vehicle, etc. that needs to preemptively charge a battery. In the vehicle, etc. described above, when the fuel cell is exposed to a high output section during a preset time, in order to prevent the durability deterioration of the fuel cell, the fuel cell may be lowered less than a preset output (output limit mode) or enter a mode (FCS: fuel cell stop) in which the vehicle stops outputting and is driven only by the battery output. When the residual hydrogen storage amount is large, even after the fuel cell is exposed to the high output section, the output command value of the fuel cell is not lowered. Therefore, the fuel cell is not controlled to enter the FCS mode at that time point, so that both the efficiency and the durability of the fuel cell may be significantly deteriorated.

However, with introduction of the residual available energy, i.e., hydrogen amount used up to the output limit mode or the FCS mode and the energy other than the residual hydrogen storage amount, the output command of the fuel cell may be designed to be lowered after the fuel cell is exposed to the high output section. Therefore, in determining the residual available energy of the fuel cell at that time point, when the residual available energy is high, i.e., the battery SOC is sufficiently provided up to the output limit mode, the output command value of the fuel cell may be lowered so that the durability of the fuel cell may increase.

Furthermore, when the residual available energy is low, for example, in the state in which the battery SOC is not sufficiently provided up to the output limit mode, the output command value is increased. A constant battery SOC may be provided in advance, whereby the fuel cell may stably enter the output limit mode in which a vehicle, etc. significantly depends on the battery. Therefore, when the present disclosure is applied to a vehicle, etc. requiring high durability and a long driving period, effects of the high efficiency and the durability improvement such as the output limit mode may be actually obtained.

FIG. 1 is the block diagram showing the controller for operating a fuel cell according to an embodiment of the present disclosure. In the system generating an output through the fuel cell F and the battery B, the controller C of operating a fuel cell includes the input part I receiving the system request output of a user, the calculating part A calculating the fuel cell output by excluding the battery output from the system request output of the user, and deriving the battery output through the plurality of factors. The plurality of factors may include the residual available energy of the fuel cell, and the operating part O controlling the operation of the fuel cell in response to the fuel cell output calculated from the calculating part A.

The calculating part A may derive the residual available energy of the fuel cell by subtracting accumulative consumed energy from initial available energy of the fuel cell. The residual available energy of the fuel cell may be derived by subtracting energy calculated through the amount of hydrogen used up to a stage in which operation of the fuel cell is terminated from available energy determined before or at an initial stage of the start-up of the fuel cell.

The present disclosure considers the battery output first as the operation system generating an output through the fuel cell and the battery. As the fuel cell output is derived by excluding the battery output first from the system request output, the durability deterioration of the fuel cell generated when the system corresponds to the system request output only when the fuel cell output is minimized.

In addition, the present disclosure considers the residual available energy of the fuel cell in deriving the battery output. The residual available energy of the fuel cell is energy that has to be secured from the present time on using the fuel cell to the output limit mode or a fuel cell limit state such as an FCS mode, etc. The residual available energy of the fuel cell is an energy driving a vehicle, etc. only with the battery SOC even in an output limit state. The residual available energy of the fuel cell may be realized by prediction through simulation, measurement through performance and durability tests, an extension value of linear regression or curve fitting on the basis of the measurement value, or an interpretation program of the fuel cell while the output limit state is preset.

Furthermore, the residual available energy ΔE of the fuel cell may be derived by subtracting the accumulative consumed energy from the initial available energy E₀ of the fuel cell. The initial available energy E₀ of the fuel cell may be defined as energy available for the fuel cell to reach the output limit state when it is assumed that the fuel cell is filled with hydrogen up to the maximum amount of hydrogen storage.

In deriving the initial available energy of the fuel cell, the calculating part may derive the initial available energy of the fuel cell on the basis of the lowest minimum output limit value of the plurality of output limit values and the maximum fuel cell available time corresponding to the minimum output limit value. The initial available energy may be determined in response to a longest available time T3 taken to reach the maximum amount of hydrogen storage of the fuel cell according to that according to the lowest output limit value P3 (E₀=P3×T3). Such an output limit and available time may be derived experimentally by detecting the durability condition of the fuel cell, i.e., the durability of the fuel cell is not deteriorated even when the fuel cell is operated with the preset output until the preset available time.

∫P(t)dt×(used time). The energy actually consumed by the fuel cell is a value that is the sum of electric energy used to drive a vehicle, etc., thermal energy generated as the fuel cell is used, thermal energy that has to be used more because of the weighted value increased in response to the performance and durability deterioration, and energy that cannot be used for other work.

Therefore, according to an embodiment of the present disclosure, all the accumulative consumed energy described above is considered in calculating the residual available energy of the fuel cell. Unlike an existing accumulated energy, the accumulated energy of the present disclosure may reflect a deteriorated condition in performance and durability of the fuel cell up to the output limit state of the fuel cell. Therefore, the effect of improving durability of the output limit system is further maximized.

FIG. 2 is a graph showing output-weight of the fuel cell with application of the controller for operating a fuel cell according to an embodiment of the present disclosure. The calculating part may have weight data with respect to a relationship between the fuel cell output and the weight, and may derive the accumulative consumed energy in consideration of both the output and the weight. The weight of the weight data may be increased as the fuel cell output is increased.

∫P(t)dt
∫P(t)dt τ(t) is weight).

As shown in FIG. 2, when the weight is calculated through linearly fitting with a straight line to correspond to the equivalent energy concept and the output value of the fuel cell, the weight may be calculated as shown in the following Equation 3.

E₀=P1×T1=P2×T2×β=P3×T3×α [Equation 3]

τ(t)=1(0≤P(t)≤P1)

τ(t)=1+[{(β−1)/(P2−P1)}×(P(t)−P1)](P1≤P(t)≤P2)

τ(t)=1+[{(α−1)/(P3−P2)}×(P(t)−P2)](P2≤P(t)≤P3)

wherein E₀ is the initial available energy of the fuel cell, P1, P2, and P3 are three output limits preset differently from each other, T1, T2, T3 is the available time corresponding to each of the output limits, τ(t) is the weight in response to the present time, and P(t) is output of the fuel cell in response to the present time.

Meanwhile, the calculating part may derive residual available time of the fuel cell on the basis of the residual available energy of the fuel cell and the output value of the fuel cell. Specifically, the residual available time of the fuel cell may be derived with the following Equation 4. Therefore, according to an embodiment of the present disclosure, the controller for operating a fuel cell may derive the residual available time of the fuel cell corresponding to a preset output value rather than the differently preset output limits, and thus provide the information about the residual available time to the driver driving a vehicle, etc. through the fuel cell, whereby the controller may induce the driver to preemptively charge the battery.

$$Δ T ( t ) = \frac{Δ E ( t )}{τ ( t ) P ( t )} \qquad [ Equation 4 ]$$

wherein ΔT(t) is the residual available time of the fuel cell, ΔE(t) is the residual available energy of the fuel cell, τ(t) is the weight in response to the present time, and P(t) is the output of the fuel cell in response to the present time.

In the graph 200 shown in FIG. 2, the horizontal axis is present output P(t) of the fuel cell and the vertical axis is the weight τ(t) obtained through the weight data about the relationship between the output of the fuel cell and the weight. In FIG. 2, β, α

E₀=1×P₃×T₃=β×P₂×T₂=α×P₁×T₁
τ(t) of the fuel cell at P3, P2, and P1 as 1, β, and α, and setting values between P3, P2, and P1 in a straight line through curve-fitting. Therefore, the residual available energy ΔE derived as described above is calculated as ΔE=E₀−∫τ(t)dt by subtracting the accumulative consumed energy (∫τ(t)P(t)dt) calculated through the weight data about the output-weight relationship from the initial available energy E₀.

As described above, the weight data about the relationship between the output and the weight may be sufficiently realized by experimental measurement through the performance and durability tests of the fuel cell, by a linear or curved trend line drawn on the basis of the measured value as shown in FIG. 2, by the extension value derived from the linear regression or the curve fitting of a trend line of existing measured values, by using the interpretation program; or by expectation through simulation on the output and the weight of the fuel cell.

As shown in FIG. 2, according to an embodiment of the present disclosure, the weight of the weight data may be increased as the fuel cell output is increased. The weight τ(t) may be interpreted as a ratio of the accumulative energy used for the fuel cell to drive a vehicle, etc. to consumed energy further consumed by thermal energy generated by the performance and durability deterioration. However, when the weight is preset regardless of the output of the fuel cell or as a constant value for each output section of the fuel cell, the characteristics of the deterioration in durability of the fuel cell may not be properly reflected. In general, the durability deterioration of the fuel cell does not occur due to long-time exposure to a low-output section, but rather occurs due to exposure of the fuel cell to a high-output section even for a short time. The durability deterioration of the fuel cell occurs as the fuel cell is operated at high-output so that it is difficult to control the temperature by cooling water, and the fuel cell is in high temperature and dry conditions, and resistance is increased.

Therefore, it is preferable that the residual available energy is calculated through the weight increased in response to the output of the fuel cell. The residual available energy calculated as described above may have smaller amount of energy as the output becomes higher than existing residual available energy. Therefore, the weight in the operating controller of the present disclosure may reflect the degree of the performance and durability deterioration more actively than the existing weight, which is accumulated in the high temperature and dry condition as the fuel cell is exposed to the high-output section. Accordingly, the output of the fuel cell is controlled to be increased in advance before the fuel cell enters the output limit mode, whereby the battery may be preemptively charged to secure both the fuel efficiency and the durability of the fuel cell of a vehicle, etc. in the output limit mode.

FIG. 1 is a block diagram 100 showing the controller for operating a fuel cell according to an embodiment of the present disclosure. The calculating part A drives the battery output through the plurality of factors, and the factors may include the residual available energy of the fuel cell and the battery SOC. Furthermore, the calculating part A derives the battery output through the plurality of factors, and the factors may include the residual available energy of the fuel cell and the system request output of the user. Furthermore, the factors may include the residual available energy of the fuel cell, the battery SOC, and the system request output of the user. Lastly, the calculating part A may derive the battery output through Equation 1.

$${P}_{bat} = {η}_{1} \times {P}_{req} + {η}_{2} \times SOC + {η}_{3} \times ( \frac{Δ E}{{E}_{0}} - 1 ) \times {P}_{req} \qquad [ Equation 1 ]$$

wherein P_{bat} is the output of the battery, η₁, η₂, and η₃ are constants, SOC is the charging amount of the battery, ΔE is the residual available energy of the fuel cell, E₀ is the initial available energy of the fuel cell, and P_{req} is the system request output of the user.

According to an embodiment of the present disclosure, the calculating part A drives the battery output through the plurality of factors, and the factors may include the residual available energy of the fuel cell and the battery SOC. According to an embodiment of the present disclosure, the calculating part A calculates the fuel cell output for controlling operation of fuel cell by the operating part O by excluding the battery output from the system request output of the user. When the battery output P_{bat} is derived to be lowered as the residual available energy ΔE of the fuel cell is less, the fuel cell output that is controlled may be increased so that the battery SOC may be preemptively maintained.

However, a variable that must be considered is the battery SOC. The battery output P_{bat} is increased as the battery SOC is higher, and the fuel cell output that is controlled in response to the battery output is lowered so that the durability of the fuel cell is protected. Therefore, according to the embodiment of the present disclosure considering both the residual available energy ΔE of the fuel cell and the battery SOC, as the battery SOC is preemptively secured before the fuel cell enters the output limit state, the effect of lowering the fuel cell output in the state of the battery SOC secured in advance may be doubled in addition to the improvement effect in the durability.

Furthermore, the factors may include the residual available energy of the fuel cell and the system request output of the user. The durability of the fuel cell is protected, as the battery output is increased as a load of a vehicle, etc. is higher to calculate the fuel cell output being lower. The variable considered as described above, i.e., the system request output P_{req} of the user, is not the input or output that is input from the user interface U.

The system request output P_{req} of the user means not only simple output required to drive a vehicle by the user depressing an accelerator pedal, but also whole output generated as described above required to a system of a vehicle. Therefore, the calculating part A may derive the output of the fuel cell in response to the system request output, i.e., the entire load of a vehicle, etc. in consideration of both the acceleration performance of a vehicle, etc. and the accumulated deterioration in cooling water performance due to the usage of the fuel cell. Therefore, according to the embodiment of the present disclosure, the effect of durability improvement obtained by lowering the output in the high output section may be doubled.

Furthermore, the factors may include the residual available energy of the fuel cell, the battery SOC, and the system request output of the user. Therefore, with the more residual available energy that can be used up to the output limit mode, the more sufficient battery SOC, and the more high load of a vehicle, etc., the output of the fuel cell is lowered so that the durability of the fuel cell can be improved.

Specifically, the factors are input into the input part I through the fuel cell F, the battery B, and the user interface U that are different devices, and the factors are processed by the calculating part C. Therefore, the factors may be universally used in the system generating the output by using the fuel cell and the battery as the embodiment of the present disclosure. In addition, the devices may be operated in conjunction with each other to further secure the durability required by the vehicle and the driving period in response to the durability.

Furthermore, the calculating part A may derive the battery output by Equation 1.

$${P}_{bat} = {η}_{1} \times {P}_{req} + {η}_{2} \times SOC + {η}_{3} \times ( \frac{Δ E}{{E}_{0}} - 1 ) \times {P}_{req} \qquad [ Equation 1 ]$$

wherein Pa is the output of the battery, η₁, η₂, and η₃ are constants, SOC is the charging amount of the battery, ΔE is the residual available energy of the fuel cell, Eₙ is the initial available energy of the fuel cell, and P_{req} is the system request output of the user.

In other words, according to the embodiment of the present disclosure, a compensation amount suitable for a specific vehicle is preset as the three variables described above, the residual available energy ΔE of the fuel cell is reflected to the battery output as a difference between the residual available energy ΔE and the initial available energy E₀ of the fuel cell ((ΔE−E₀)/E₀), and the residual available energy is multiplied by the system request output P_{req} of the user so that the fuel cell output may be controlled. Therefore, even when the high load is applied to a vehicle, etc., the weight may be applied with high available energy, so that the output of the fuel cell is not further required. Furthermore, as the replacement and recycling of the battery or the fuel cell, maintenance of a vehicle, etc., or a reversely changed state are reflected to determine the compensation amount, the fuel cell output may be controlled. Therefore, the present disclosure may be applied suitably for a specific vehicle, etc. that requires the durability, and the fuel cell output may be dynamically controlled by properly reflecting a change in a condition of the vehicle.

FIG. 4 is a graph 400 showing output-weight with application of the controller for operating a fuel cell according to the embodiment of the present disclosure. According to the embodiment of the present disclosure, the residual available energy of the fuel cell calculated from the accumulative consumed energy of the fuel cell calculated by the weight may be variably derived by a parameter accumulated in response to the usage of the fuel cell. In addition, the residual available energy of the fuel cell may be reduced as the parameter accumulated in response to the usage of the fuel cell is reduced. The amount of the deterioration in the durability of the fuel cell due to the use of the fuel cell may be reflected to calculate the residual available energy of the fuel cell.

The usage of the fuel cell includes not only generating energy by simply consuming hydrogen in the fuel cell, but also deterioration in the existing output performance of a normal fuel cell in response to works for maintaining basic functions of the fuel cell such as maintenance, replacement, or recycling of the fuel cell or to failures, malfunctions, over/under-operation, and abuse of the fuel cell. Therefore, according to the embodiment of the present disclosure, as the fuel cell output is controlled by deriving the residual available energy of the fuel cell with the parameter accumulated in response to the usage of the fuel cell, an average degree of the durability deterioration of the fuel cell is properly applied, whereby the durability deterioration may be stably prevented.

In addition, the residual available energy of the fuel cell may be reduced as the parameter accumulated in response to the usage of the fuel cell is reduced. The residual available energy of the fuel cell that can be used up to the output limit mode is reduced as the accumulated hydrogen usage time of the fuel cell deteriorates the durability and the performance of the fuel cell. Specifically, the fuel cell is moved from a BOL (beginning of life) stage to an EOL (end of life) stage in response to accumulated hydrogen usage. In the EOL stage, the fuel cell is exposed to the high-output section, the durability of the fuel cell is deteriorated. Nevertheless, when the output of the fuel cell derived by the residual available energy of the existing fuel cell is controlled, the battery SOC that should be used in the output limit mode is not provided in advance. Specifically, in response to the degree in which the fuel cell is exposed to the high output section in a stage close to the EOL, the residual available energy of the fuel cell is significantly deteriorated. Therefore, as the control system is designed by a parameter proportional to the performance deterioration due to the hydrogen usage of the fuel cell as the parameter as described above, the durability deterioration can be prevented in advance.

The graph in FIG. 2 is shown in the graph in FIG. 4 by a solid line, wherein a portion in which the weight is increased according to the parameter accumulated by the use of the fuel cell is shown by a dotted line. The view shows the residual available energy of the fuel cell variably derived as the weight τ(t) of the fuel cell is increased and reduced. Specifically, the dotted line in FIG. 4 shows the weight τ′(t) modified high obtained as the preset output level P3, P2, P1 of the fuel cell, which is used in FIG. 2, is reduced by the ratio of the parameter (r, r<1) (P3′=P3×r, P2′=P2×r, P1′=P1×r).

The graph in FIG. 4 is created by marking the weight τ′(t) of the fuel cell as 1, β, and α at P3′, P2′, and P1′ according to new output levels (P3′=P3×r, P2′=P2×r, P1′=P1×

E₀′=1×P₃′×T₃=β×P₂′×T₂=α×P₁′×T₁

ΔE=E₀−∫τ(t)′P(t)dt) derived through the increased weight τ

FIG. 3 is a graph 300 showing a ratio of an initial current of the fuel cell in a preset output value of the fuel cell to a voltage after a preset usage time of the fuel cell in the controller for operating a fuel cell according to an embodiment of the present disclosure, and the parameter may be a ratio of an initial voltage of the fuel cell in a preset output of the fuel cell to a voltage after a preset usage time of the fuel cell. A voltage ratio in the parameter accumulated in response to the use of the fuel cell is used.

In FIG. 3, the horizontal axis is a preset output command value P_{fc} of the fuel cell (output is increased toward the left), and the vertical axis is the initial voltage V_{BOL} of the fuel cell and a voltage V(t) after the preset usage time of the fuel cell. As shown in FIG. 3, unlike the initial voltage BOL of the fuel cell, a voltage lower than the existing fuel cell is generated in response to the durability deterioration due to the usage of the fuel cell. Although the voltages are measured as the output of the same fuel cell and the fuel cell is controlled through the measured output, a lower output is actually generated due to a lower voltage in response to a durability condition. Therefore, in the fuel cell with deteriorated durability, even in the same low output command value, a value determined as a lower output in the BOL stage is determined as a high output at the EOL stage. Therefore, even when the fuel cell does not preemptively charge the battery in case of the output limit mode because the residual available energy of the fuel cell is high, the fuel cell is exposed to the high-output so that the durability of the fuel cell may be significantly deteriorated.

Therefore, it is preferable to derive the residual available energy of the fuel cell by reflecting the durability condition of the fuel cell. The parameter accurately reflecting the durability condition of the fuel cell is a ratio (V(t)/V_{BOL}) of an initial voltage of the fuel cell at a preset output of the fuel cell to a voltage after a preset usage time of the fuel cell. According to the embodiment of the present disclosure, the residual available energy of the fuel cell is derived by being reduced in response to the output of the fuel cell reduced in response to the durability condition of the fuel cell. Specifically, the parameter (V(t)/V_{BOL}) is a variable reduced linearly with respect to the output of the fuel cell. Therefore, when the residual available energy controlled according to the parameter is high, the output of the fuel cell is reduced so that the fuel cell is not exposed to the high output section, and when the residual available energy is low, the output of the fuel cell is increased in advance to stably prepare for the following output limit mode. The embodiment of the present disclosure can be applied to applications such as a commercial vehicle requiring long-term operation, a ship, and aviation, where the driving period expected at the initial BOL stage of the fuel cell may be satisfied at the following EOL stage.

FIGS. 3 and 4 are views showing that the weight is rebalanced (τ(t)->τ(t)′) by applying the output of the fuel cell (P3′=P3×V(t)/V_{BOL}, P2′=P2×V(t)/V_{BOL}, P1′=P1×V(t)/V_{BOL}) reduced by the same ratio through the parameter described above, and then the control to increase the accumulative consumed energy (∫τ(t)P(t)dt->∫τ(t)′P(t)dt) of the fuel cell is increased and to lower the residual available energy (ΔE′=E₀−∫τ(t)′P(t)dt) of the fuel cell are performed.

The parameter may be a ratio of the initial available energy of the fuel cell in a preset output of the fuel cell to the initial available energy after a preset usage time of the fuel cell or a ratio of the maximum amount of the hydrogen storage of the fuel cell in a preset output of the fuel cell to the maximum amount of the hydrogen storage after a preset usage time of the fuel cell. The durability condition of the fuel cell may be reflected even by the ratio of the present initial available energy E₀ of the fuel cell compared to the BOL stage of the fuel cell to the maximum amount of the hydrogen storage of the fuel cell. The fuel cell is configured such that the output same as the voltage is reduced in response to the hydrogen use, and thus increase the weight τ(t). Therefore, even when the same amount of hydrogen is maximally stored in the hydrogen storage system, the actual maximum hydrogen storage of the fuel cell is reduced in response to the high weight. Therefore, in order to properly reflect the durability condition of the fuel cell, not only the reduction of output of the fuel cell but also the reduction of available time of the fuel cell is considered.

As described above, the initial available energy of the fuel cell may be determined in response to the available time T3 (E₀=P3×T3). the available time T3 is consumed time until the fuel cell is used up to the maximum amount of the hydrogen storage of the fuel cell in response to a low output P3, and the low output is experimentally derived such that the durability deterioration of the fuel cell is not affected even when the fuel cell is continuously operated at an arbitrary output level.

Therefore, unlike when only the output and the weight are modified (P3′=P3×V(t)/V_{BOL}, τ(t)->τ(t)′) according to the voltage ratio (V(t)/V_{BOL}) as shown in FIG. 4, the available time T3′ reduced in response to the durability deterioration of the fuel cell may also modified according to a reduction ratio r of the maximum amount of the hydrogen storage of the fuel cell (T3′=T3×r). Accordingly, the initial available energy of the fuel cell may be modified as follows (E₀′=P3′×T3′). Therefore, in deriving the residual available energy (ΔE′=∫τ(t)′P(t)dt) of the fuel cell, the maximum amount of the hydrogen storage of the fuel cell reduced in response to the durability deterioration may also be reflected. Therefore, when embodiments of the present disclosure are applied to applications such as commercial vehicles, ships, and, aviation to which the output limit mode is preset, the driving available period at a level expected in the BOL stage of the fuel cell may be satisfied in the following EOL stage as the available time (T3′=T3×r) of the fuel cell is modified in response to the durability condition.

FIG. 5 is a flowchart 500 showing a controlling method of operating a fuel cell according to an embodiment of the present disclosure. According to an embodiment of the present disclosure, a controlling method of operating a fuel cell, the controlling method of operating a fuel cell in the system generating the output by the fuel cell and the battery, the controlling method includes: receiving, by the input part, the system request output of the user at S100, deriving, by the calculating part, the battery output through the plurality of factors including the residual available energy of the fuel cell at S200, S300, deriving, by the calculating part, the fuel cell output by excluding the battery output from the system request output of the user at S300, and controlling, by the operating part, the operation of the fuel cell in response to the fuel cell output at S400.

According to an embodiment of the present disclosure, the controlling method of operating a fuel cell is a method of limiting the output of the fuel cell or of controlling the operation thereof by receiving the information about a vehicle, etc. Specifically, in the case of the method generating the output through the fuel cell and the battery as described in an embodiment of the present disclosure, the input part receives, as the information about a vehicle, etc., the battery SOC, etc. from the battery, the fuel cell output, etc. from the fuel cell F, and the system request output, etc. from the user interface U at S100. The input part may receive the information about an output limiting value of each device for improving the durability of a vehicle. In addition, as the voltage ratio (V(t)/V_{BOL}), the parameter accumulated in response to the use of the fuel cell may be input to determine the durability.

The calculating part calculates the residual available energy ΔE on the basis of the information about a vehicle, etc. input from the input part at S200. Specifically, in order to calculate the residual available energy (ΔE), both the initial available energy E₀ and the accumulative consumed energy (∫τ(t)P(t)dt) of the fuel cell may be calculated in advance or simultaneously. In addition, the calculating part may have the weight data about the relationship between the output P(t) and the weight τ(t), and may derive the accumulative consumed energy (∫τ(t)P(t)dt) in consideration of both the output and the weight. Meanwhile, the output and the weight are modified (τ(t)->τ′(t)) through the output ratio (V(t)/V_{BOL}) to variably derive the residual available energy (ΔE->ΔE′).

Next, the battery output P_{bat} is derived through the plurality of factors such as the residual available energy ΔE calculated and the information about a vehicle, etc. at S300. The battery output maybe derived through the factors including the residual available energy ΔE, the battery SOC, the residual available energy ΔE, and the system request output P_{req} of the user, or the residual available energy ΔE, the battery SOC, and the system request output ΔE of the user. Next, the fuel cell output is calculated by excluding the battery output P_{bat} from the system request output P_{req} (P_{tc}=Preq−P_{bat}) at S300.

As a final stage, the operating part converts the signal in response to the output P_{fc} of the fuel calculated from the calculating part, i.e., the output command value of the fuel cell, through a FDC (Fuel Cell DC-DC Converter, the fuel cell output converter) to lastly controlling the operation of the fuel cell at S400.

Then, the drive part drives a vehicle, etc. through the motor in response to the fuel cell output and the battery output that are controlled as described above. The above operation will be repeated from the start until the operation of the fuel cell is completed at S500.

According to the embodiment of the present disclosure, the controlling method of operating a fuel cell is designed such that the output command value of the fuel cell is lowered after the fuel cell is exposed to the high output section while introducing the residual available energy, i.e., hydrogen amount used up to the output limit mode or the FCS mode and the energy, not the residual hydrogen storage. Therefore, in determining the residual available energy of the fuel cell at a present time, when the residual available energy is high, i.e., the battery SOC is sufficiently provided up to the output limit mode, the output command value of the fuel cell may be lowered to increase the durability of the fuel cell.

Furthermore, when the residual available energy is low, and in other words, in the state in which the battery SOC is not sufficiently provided up to the output limit mode, the output of the fuel cell, i.e., the output command value is increased. A constant battery SOC may be provided in advance, whereby the fuel cell may stably enter the output limit mode in which a vehicle, etc. significantly depends on the battery. Therefore, when the present disclosure is applied to a vehicle, etc. requiring high durability and long driving period, effects of the high efficiency and the durability improvement such as the output limit mode may be actually obtained.

In addition, in the controlling method of operating a fuel cell according to the embodiment of the present disclosure as shown in FIG. 5, in the deriving, by the calculating part, the battery output through the plurality of factors including the residual available energy of the fuel cell at S200, S300, the residual available energy of the fuel cell is derived by subtracting the accumulative consumed energy from the initial available energy of the fuel cell.

∫P(t)dt×(used time). The energy actually consumed by the fuel cell is a value that is sum of electric energy driving a vehicle, etc., thermal energy generated as the fuel cell is used, thermal energy that has to be used more because the weight lowered in response to deterioration in performance and durability, and energy that cannot be used for other work.

Therefore, according to the embodiment of the present disclosure, all the accumulative consumed energy described above is considered in calculating the residual available energy of the fuel cell. Unlike an existing accumulated energy, the accumulated energy of the present disclosure may reflect a deteriorated condition in performance and durability of the fuel cell up to the output limit state of the fuel cell. Therefore, the effect of improving durability of the output limit system is further maximized.

Meanwhile, in the method of controlling the operation of the fuel cell according to the embodiment of the present disclosure as shown in FIG. 5, in the deriving, by the calculating part, the battery output through the plurality of factors including the residual available energy of the fuel cell at S200, S300, the residual available energy of the fuel cell is variably derived through the parameter accumulated in response to the use of the fuel cell.

The residual available energy of the fuel cell that can be used up to the output limit mode is reduced as the accumulated hydrogen usage time of the fuel cell deteriorates the durability and the performance of the fuel cell. Specifically, the fuel cell is moved from BOL (beginning of life) stage to EOL (end of life) stage in response to accumulated hydrogen usage. In the EOL stage, the fuel cell is exposed to the high-output section, the durability of the fuel cell is deteriorated. Nevertheless, when the output of the fuel cell derived by the residual available energy of the existing fuel cell is controlled, resulting that the battery SOC that should be used in the output limit mode is not provided in advance.

Specifically, in response to the degree in which the fuel cell is exposed to the high output section in a stage close to the EOL, the residual available energy of the fuel cell is significantly deteriorated. Therefore, as the control system is designed by a parameter proportional to the performance deterioration due to the hydrogen usage of the fuel cell as the parameter as described above, the durability deterioration can be prevented in advance.

The present disclosure relates to the controller and the controlling method of operating a fuel cell and, more particularly, to the controller and the controlling method of operating a fuel cell, which are configured to control the output of the fuel cell for expecting and preparing the output limit state and the durability deterioration of the fuel cell in the system generating the output through the fuel cell and the battery.

In a system in which both a fuel cell system and a high capacity battery are applied, when the fuel cell output is insufficient, the battery may supply the insufficient output. Therefore, a technique preparing to supply the total request output in the fuel cell output limit by preemptively charging the battery on the basis of the fuel cell output limiting time is required. However, the output used from the fuel cell has a continuous value less than the maximum output. Therefore, when the output is not in a preset output value, the output limit may not be considered in advance with the existing information.

Accordingly, according to the present disclosure, in controlling the output value of the fuel cell, the variable output command of the user may be stably satisfied in consideration of the battery SOC calculated in case of the output limit state, and not by using only the output data of the fuel cell. The output command value of the fuel cell is variably derived in response to the durability condition of the fuel cell so that the durability of the fuel cell can be increased.

Although the preferred embodiments of the present disclosure have been described for illustrative purposes, those skilled in the art will appreciate that various modifications, additions and substitutions are possible, without departing from the scope and spirit of the disclosure as disclosed in the accompanying claims.

What is claimed is:

1. A controller for operating a fuel cell in a system, the system being configured to generate an output through the fuel cell and a battery, the controller comprising:
an input part configured to receive a system request output of a user;
a calculating part configured to calculate a fuel cell output by excluding a battery output from the system request output of the user, the battery output being derived through a plurality of factors, the plurality of factors including residual available energy of the fuel cell; and
an operating part configured to control the operation of the fuel cell in response to the fuel cell output calculated by the calculating part.

2. The controller of claim 1, wherein the calculating part is configured to derive the residual available energy of the fuel cell by subtracting an accumulative consumed energy from an initial available energy of the fuel cell.

3. The controller of claim 2, wherein the calculating part is configured to derive the initial available energy and the accumulative consumed energy of the fuel cell on the basis of a plurality of output limit values preset as different values and fuel cell available time corresponding to the output limits.

4. The controller of claim 3, wherein, in deriving the initial available energy of the fuel cell, the calculating part derives the initial available energy of the fuel cell on the basis of a lowest minimum output limit value of the plurality of output limit values and maximum fuel cell available time corresponding thereto.

5. The controller of claim 1, wherein the calculating part is configured to derive residual available time of the fuel cell on the basis of the residual available energy of the fuel cell and an output value of the fuel cell.

6. The controller of claim 1, wherein the factors of the calculating part include the residual available energy of the fuel cell and a state of charge (SOC) of the battery.

7. The controller of claim 1, wherein the factors of the calculating part include the residual available energy of the fuel cell and the system request output of the user.

8. The controller of claim 1, wherein the factors of the calculating part include the residual available energy of the fuel cell, a state of charge (SOC) of the battery, and the system request output of the user.

9. The controller of claim 1, wherein the calculating part is configured to derive the battery output through an equation
$${P}_{bat} = {η}_{1} \times {P}_{req} + {η}_{2} \times SOC + {η}_{3} \times ( \frac{Δ E}{{E}_{0}} - 1 ) \times {P}_{req}$$
wherein P_{bat} is the output of the battery, η₁, η₂, and η₃ are constants, SOC is a state of charge of the battery, ΔE is the residual available energy of the fuel cell, E₀ is an initial available energy of the fuel cell, and P_{req} is the system request output of the user.

10. The controller of claim 1, wherein the residual available energy of the fuel cell is variably derived on the basis of a parameter changed as accumulative usage time of the fuel cell is increased.

11. The controller of claim 10, wherein the residual available energy of the fuel cell is reduced as the parameter is reduced, the parameter being changed as the accumulative usage time of the fuel cell is increased.

12. The controller of claim 11, wherein the parameter is a ratio of a voltage value in an initial performance state of the fuel cell to a voltage value due to reduced durability after the accumulative usage time of the fuel cell, with respect to a preset output value of the fuel cell.

13. A controlling method of operating a fuel cell in a system, the system being configured to generate an output through the fuel cell and a battery, the controlling method comprising:
receiving, by an input part, a system request output of a user;
deriving, by a calculating part, an output of the battery through a plurality of factors including residual available energy of the fuel cell;
calculating, by the calculating part, an output of the fuel cell by excluding the output of the battery from the system request output of the user; and
controlling, by an operating part, operation of the fuel cell in response to the output of the fuel cell.

14. The controlling method of claim 13, wherein in the deriving, by the calculating part, the output of the battery through the plurality of factors including the residual available energy of the fuel cell, the residual available energy of the fuel cell is derived by subtracting accumulative consumed energy from initial available energy of the fuel cell.

15. The controlling method of claim 13, wherein in the deriving, by the calculating part, the output of the battery through the plurality of factors including the residual available energy of the fuel cell, the residual available energy of the fuel cell is variably derived on the basis of a parameter, the parameter being changed as an accumulative usage time of the fuel cell is increased.
